(19) United States
(12) Patent Application Publication
(10) Pub. No.: US 2008/0011130 A1
(43) Pub. Date: Jan. 17, 2008

(54) Method For Clamping And Turning A Vehicle Wheel Shape

(76) Inventor: Larry C. Smyth, Annapolis, MD (US)

Correspondence Address: SCHWARTZ LAW FIRM, P.C., 6100 FAIRVIEW ROAD, SUITE 11350, CHARLOTTE, NC, 28210, US

(21) Appl. No.: 11/547,902

(22) PCT Filed: Apr. 8, 2005
(86) PCT No.: PCT/US05/12060

§ 371 Date: Oct. 6, 2006

Related U.S. Application Data
(60) Provisional application No. 60/560,662, filed on Apr. 8, 2004.

(51) Int. Cl. B23B 5/34

(52) U.S. Cl. 82/1.11

(57) ABSTRACT

A method for forming a vehicle wheel including a wheel rim defining opposing inboard and outboard annular flanges, inboard and outboard tire bead seats adjacent respective inboard and outboard flanges, and a rim barrel between the inboard and outboard tire bead seats. The method includes the step of machining a wheel shape in a clamping area adjacent one of the inboard and outboard flanges of the vehicle wheel. The clamping area of the wheel shape is then secured within a chuck of a lathe. In one chucking, the wheel shape is machined to form the inboard and outboard tire bead seats of the vehicle wheel.

### TECHNICAL FIELD AND BACKGROUND OF THE INVENTION

This invention relates broadly to the manufacture of vehicle wheels, and more specifically, to an improved method for clamping and turning a wheel shape or other cup-shaped part.

Steel wheels are almost always made of two-pieces, a center or spider, and the rim. They are also almost always made from sheet material. Aluminum wheels can be made in the same manner, but most light alloy wheels are made from either cast or forged wheel shapes. The initial styling is created by the casting mold or forging dies as are the functional wheel surfaces. These latter surfaces are formed with excess material, which is then removed in subsequent precision machining operations. Most of the initial shape is turned on lathes, and then drilling of the lug and valve holes is done on milling or drilling machines.

Machining requires proper part holding. For milling and drilling, the part needs to be positioned correctly and rigidly clamped in a fixed position. Turning on the other hand requires proper positioning and rigid clamping on a chuck of a lathe, and then the chuck and wheel assembly rotate and a non-rotating tool is moved across the part to effect the desired metal removal cutting action. Generally speaking, if the lathe is strong and powerful then it is the ability of the chuck and part to withstand the rotational forces that determines the metal removal rate and precision. Not withstanding other influences, it goes without saying that the faster one can cut a part and keep it in print tolerance, the lower the machining cost.

Wheels and similar cup shaped parts are generally turned in two operations. In the particular case of wheels, almost all cast and forged wheel shapes are held in three-jaw chucks and turned using a conventional lathe. Referring to FIG. 1, in a typical first operation turning (indicated at path “A”) of a wheel form 10, the outboard flange 11 of the wheel rim 12 is secured in a chuck (not shown), while the wheel shape 10 is machined to form surface areas including the dropwell 17, outside rim barrel 18, inboard tire bead seat 19, inboard flange 20, inside rim barrel 21, and hub mounting surface 22. In the second operation turning (indicated at path “B”), the wheel shape 10 is reversed, centered, and clamped on the inboard machined surface, and the remainder of the shape 10 is machined to form the outboard tire bead seat 23, outboard flange 11, and wheel face 25.

U.S. Pat. No. 6,126,174 describes a wheel turning operation and illustrates a conventional pullback chuck. This type of chuck is used because the pullback action not only strongly clamps the wheel, but also facilitates positively aligning the wheel on the machine centerline by clamping in the axial versus radial plane. The three jaws create a stable, but distressed clamped part. U.S. Pat. No. 5,895,059 and U.S. Application Serial No. 2002/0014142 provide more background on such three-jaw pullback chucks. All of the above references are incorporated herein by this reference.

As modern vehicles use larger wheels than prior generations, and as consumers insist on quieter and smoother running vehicles, it has become more and more of a challenge to achieve the increasingly tighter design specifications with conventional first operation—second operation turning. The '174 Patent mentioned above describes a novel technique applicable for a wheel shape 30 which utilizes an additional stepped ring 31 (See FIG. 2) formed with its outer peripheral edge. This added extension 31 is used entirely for centering and clamping purposes, and enables the inboard and outboard tire bead seats 32 and 33 to be machined in one chucking at the same time the hub mounting surface 34 and pilot bore 35 are turned. The resulting improved concentricity and parallelism of the machined wheel improves the dynamic characteristics of the tire and wheel, and a smoother vehicle ride is obtained.

While the above technique is attractive, it does require a more complex and expensive casting or forging to provide the necessary additional stepped ring or extension for clamping. After the wheel is completed, the ring extension must be removed and the remnant re-melted and reused, which is an additional cost and metal quality penalty. In view of these disadvantages, a wheel chuck and machining process that allows the tire bead seats, plus the hub mounting surface and pilot bores of a standard forged or cast shape to be machined in one chucking is highly desirable.

Another problem encountered with wheel turning is an out of round turned rim. Just as non-concentricity and non-parallelism negatively affect vehicle ride, so does non-round wheels. Notwithstanding other contributing factors, this turning-affected design requirement is kept under control by limiting the rotational speed of the chuck and part assembly. While this is generally effective, it does not allow strong and powerful lathes to achieve their true production capability. Thus, a second desired improvement is a new technique to clamp a wheel, or other cup like parts, in such a manner as to allow higher speed machining while keeping such parts within design tolerances.

### SUMMARY OF INVENTION

Therefore, it is an object of the invention to provide an improved method for forming a vehicle wheel or other cup-like shaped part.

It is another object of the invention to provide a method for forming a vehicle wheel which utilizes a standard wheel shape casting or forging without added axial structure necessary for centering and clamping the wheel shape within the chuck.

It is another object of the invention to provide a method for forming a vehicle wheel which utilizes improved clamping means which secures the wheel shape without any distortion.

It is another object of the invention to provide a method for forming a vehicle wheel which utilizes improved clamping means which uniformly engages the wheel shape along its entire circumference.

It is another object of the invention to provide a method for forming a vehicle wheel wherein the inboard and outboard tire bead seats, wheel face, and pilot bore are turned in a single chucking.

It is another object of the invention to provide a method for forming a vehicle wheel which utilizes a high speed lathe.

It is another object of the invention to provide a method for forming a vehicle wheel which enables more effective and efficient use of the machining tool.

It is another object of the invention to provide a novel multi-axis lathe capable of machining an entire wheel shape in one chucking.

These and other objects of the present invention are achieved in the preferred embodiments disclosed below by providing a method for forming a vehicle wheel. The vehicle wheel includes a wheel rim defining opposing inboard and outboard annular flanges, inboard and outboard tire bead seats adjacent respective inboard and outboard flanges, and a rim barrel between the inboard and outboard tire bead seats. The method includes the steps of machining a wheel shape in a clamping area adjacent one of the inboard and outboard flanges of the vehicle wheel. The clamping area of the wheel shape is then secured within a chuck of a lathe without distorting the wheel shape. In one chucking, the wheel shape is machined to form the inboard and outboard tire bead seats of the vehicle wheel.

The term “machining” is broadly defined herein to mean cutting, shaping or finishing.

The term “wheel shape” means any structure adapted for being machined into a wheel or wheel part, such as a wheel rim, wheel center, half wheel, and the like.

The term “distorting” as used herein means a non-uniform deformation of the wheel shape.

According to another preferred embodiment of the invention, the clamping area of the wheel shape defines an axial dimension of less than 10 mm.

According to another preferred embodiment of the invention, the method comprises further machining the wheel shape to form opposing inside and outside surfaces of the rim barrel.

According to another preferred embodiment of the invention, the method comprises further machining the wheel shape to form a hub mounting surface on an inboard side of the vehicle wheel.

According to another preferred embodiment of the invention, the method comprises further machining the wheel shape to form a wheel face on an outboard side of the vehicle wheel.

According to another preferred embodiment of the invention, the method comprises machining a second clamping area adjacent the other of the inboard and outboard flanges.

According to another preferred embodiment of the invention, the method comprises securing the second clamping area of the wheel shape within a rotatable tailstock.

In another embodiment, the invention is a method for forming a vehicle wheel comprising a wheel rim defining opposing inboard and outboard annular flanges, inboard and outboard tire bead seats adjacent respective inboard and outboard flanges, and a rim barrel between the inboard and outboard tire bead seats. The method includes the steps of securing a wheel shape within a chuck of a lathe. The chuck uniformly engages substantially an entire circumference of the wheel shape along an axial clamping area. In one chucking, the wheel shape is machined to form the inboard and outboard tire bead seats of the vehicle wheel.

In yet another embodiment, the invention is a method for forming a vehicle wheel rim defining an annular flange and a tire bead seat adjacent the annular flange. The method includes the steps of machining a wheel shape in a clamping area adjacent the annular flange of the wheel rim. The clamping area is then secured within a chuck of a lathe with out distorting the wheel shape. While secured within the chuck of the lathe, the wheel shape is then machined adjacent the clamping area to form the tire bead seat of the wheel rim.

In still another embodiment, the invention is a method for forming a vehicle wheel rim defining an annular flange and a tire bead seat adjacent the annular flange. The method includes the steps of securing a wheel shape within a chuck of a lathe. The chuck uniformly engages an outside periphery of the wheel shape along an axial clamping area. While secured within the chuck of the lathe, the wheel shape is then machined adjacent the axial clamping area to form the tire bead seat of the wheel rim.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 illustrates the machining tool paths of respective conventional first and second operation turning methods;

FIG. 2 illustrates a lathe chuck and wheel casting employed in another wheel-forming method of the prior art;

FIG. 3 illustrates a lathe chuck applicable for machining (or “turning”) a wheel shape to form a vehicle wheel according to one preferred method of the present invention;

FIG. 4 illustrates the machining tool paths of respective first and second operation turning of the wheel shape according to an embodiment of the present method;

FIG. 5 is an enlarged fragmentary view of the lathe chuck and machining tool applicable for turning the wheel shape shown in FIG. 3;

FIG. 6 is an enlarged fragmentary view of a second flange clamp applicable for securing an otherwise free end of the wheel shape during first and second operation machining;

FIG. 7 illustrates a modified conventional lathe which integrates a second flange clamp carried on an axial slide to adjust for various part widths;

FIG. 8 illustrates a lathe chuck applicable for machining a wheel shape to form a vehicle wheel according to another method of the present invention;

FIG. 9 illustrates an alternative lathe chuck applicable for machining the wheel shape according to the present invention;

FIGS. 10A, 10B, 10C, and 10D illustrate various alternative pre-machined surfaces in the clamping area of the wheel shape; and

FIG. 11 illustrates schematically a novel six-axis lathe applicable for practicing a method according to the present invention.

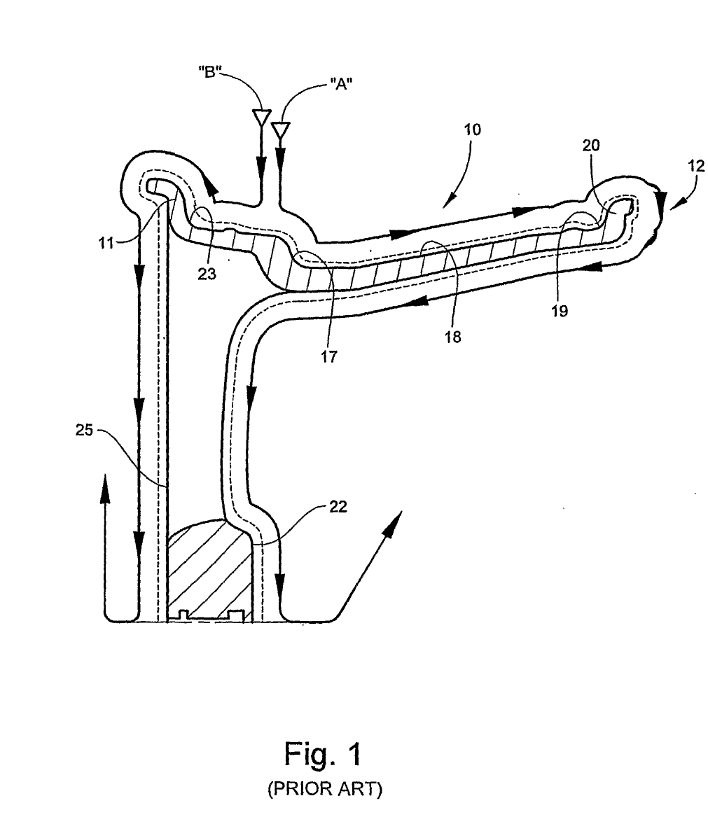

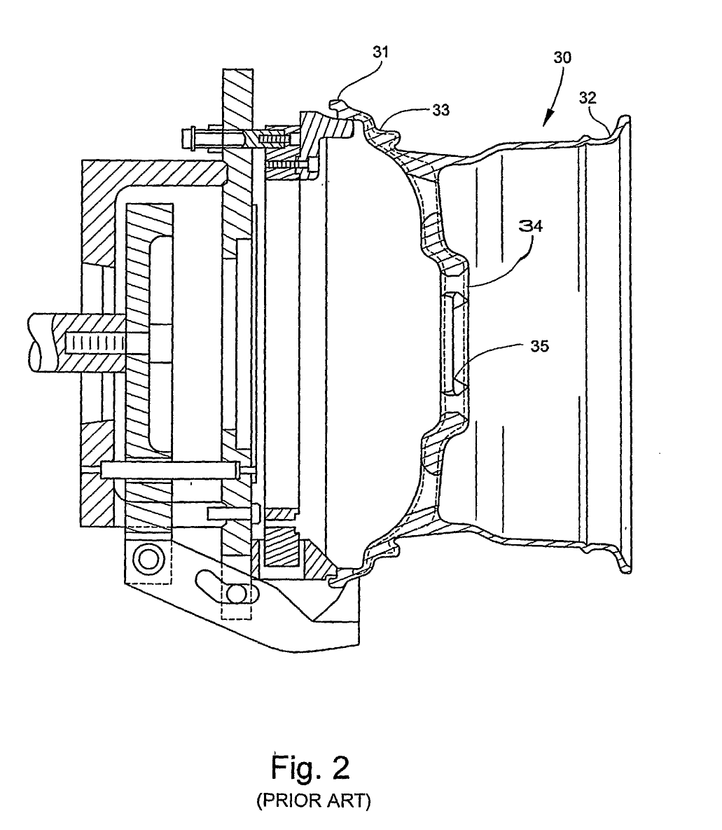

### DESCRIPTION OF THE PREFERRED EMBODIMENT AND BEST MODE

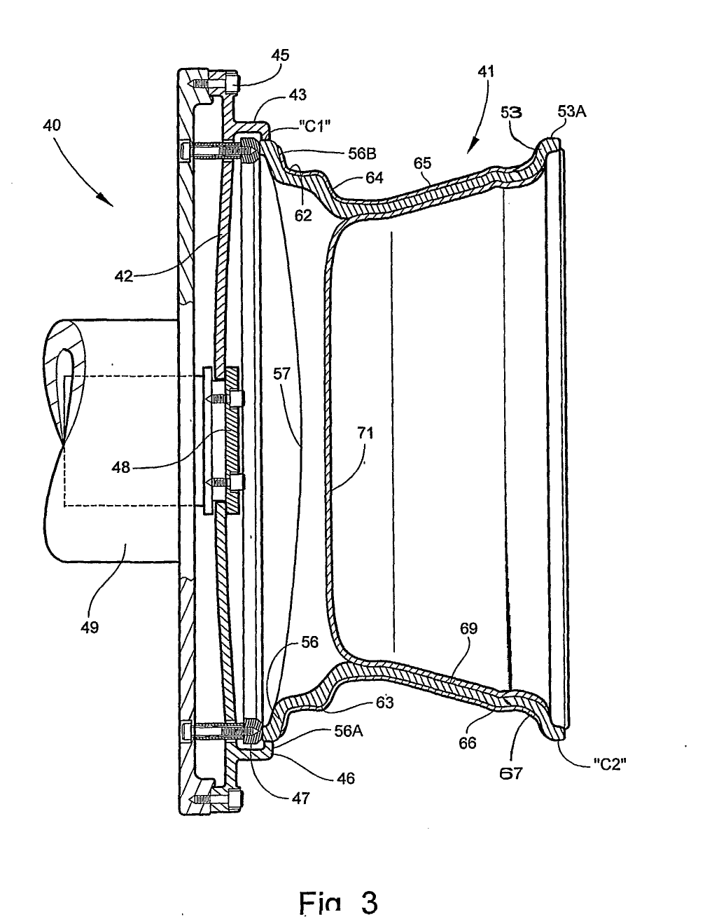

Referring now specifically to the drawings, FIG. 3 shows a chuck 40 of a lathe applicable for machining (or “turning”) a cast or forged alloy wheel shape 41 to form a vehicle wheel according to a preferred embodiment of the present invention. The chuck 40 comprises a flexible, radially-segmented diaphragm 42 including an annular clamping flange 43 designed to engage the wheel shape 41 along a small axial clamping area “C1”. This clamping area is preferably less than 10 mm. In a most preferred embodiment, the clamping area is in the range of 4-6 mm. The clamping flange 43 extends along substantially an entire circumference of the wheel shape 41—preferably, along 80-100% of the circumference.

The diaphragm 42 is fixedly secured to the chuck 40 at an outer peripheral edge by bolts 45 or other suitable fasteners. The clamping flange 43 is integrally formed with a body of the diaphragm 42, and has an annular inwardly-turned lip 46 adapted for engaging the wheel shape 41. The wheel-engaging lip 46 cooperates with an annular rest pad 47 to locate and secure the wheel shape 41 within the chuck 40. The radial clamping force acting on the wheel shape 41 is controlled by an axially adjustable center plate 48. By urging the center plate 48 inwardly towards the lathe spindle 49, the resulting operating force acting on the diaphragm 42 is transformed into a radial clamping force at the flange 43 of 5-10 times greater. This force applied to the wheel shape 41 is of uniform intensity around the entire circumference, thus guaranteeing maximum clamping accuracy and permitting the transmission of high torques. Because the wheel shape 41 is clamped in a pure radial plane, very little axial length is required to create a very strong holding force.

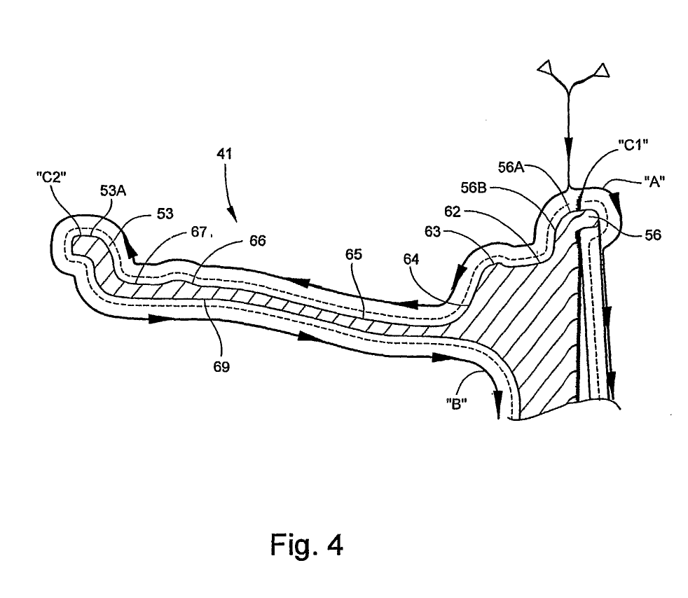

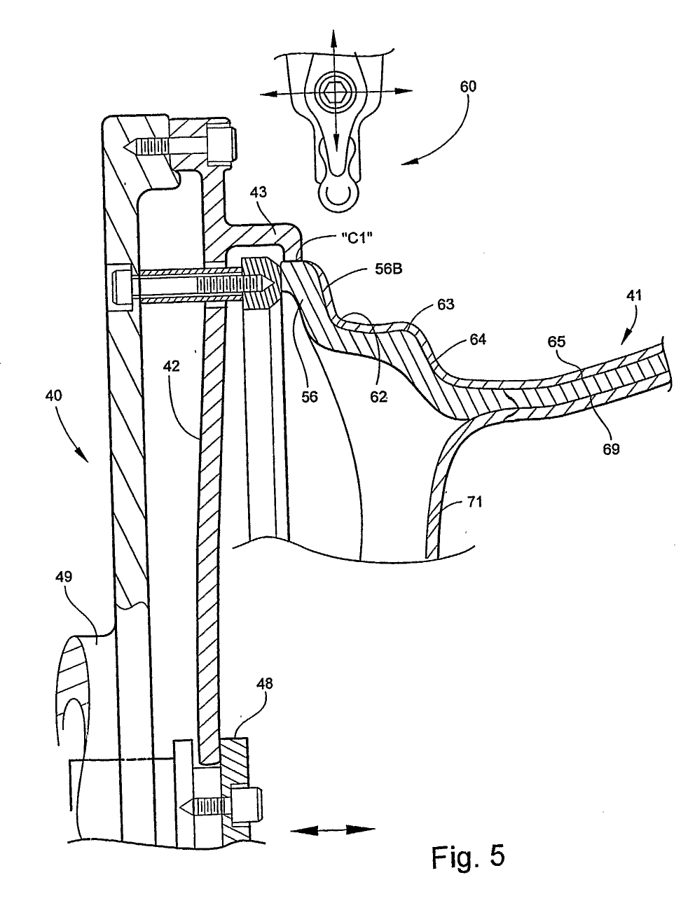

According to one preferred technique of the invention, the wheel shape 41 is first pre-machined to form an inboard axial lip 53A of the inboard flange 53. This portion 53A of the inboard flange 53 defines a clamping area “C2” which is clamped in the chuck 40, as described above. Once chucked, a first operation turning machines the wheel shape 41 along a path “A” of FIG. 4. This turning forms an opposing axial lip 56A of the outboard flange 56 and wheel face 57. After this first operation turning, the wheel shape 41 is removed from the chuck 40, reversed, and re-chucked, as shown in FIGS. 3 and 5, with the machined axial lip 56A of the outboard flange 56 defining the axial clamping area “C1” mentioned above. In the second operation turning, the machining tool 60 (shown in FIG. 5) is moved vertically downward onto the wheel shape 41 to form a vertical wall 56B of the outboard flange 56, outboard tire bead seat 62, outboard tire hump 63, dropwell 64, outside rim barrel 65, inboard tire hump 66, inboard tire bead seat 67, remaining inboard flange 53, inside rim barrel 69, and remainder of the wheel shape 41, including the hub mounting surface 71 and pilot bore (not shown)—all machined in a single chucking. This second operation turning is indicated along path “B” of FIG. 4. As an alternative technique, the inboard flange 53 would be grasped by a conventional three-jaw chuck, while the wheel shape 41 is machined to form the axial lip 56A of the outboard flange 56 and wheel face 57. After this first operation turning, the wheel form 41 would be reversed and clamped within the chuck 40 for second operation turning as described above.

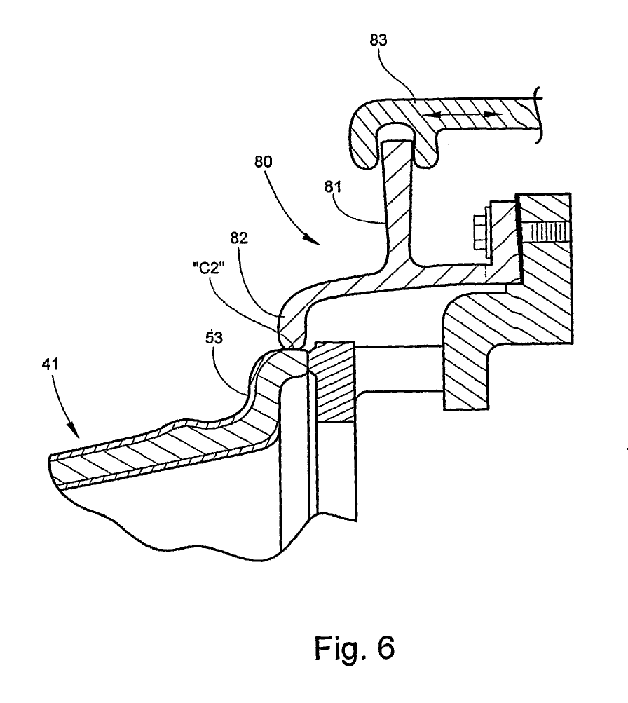

In the second operation turning discussed above, only the outboard axial lip 56A of the outboard flange 56 is clamped in the chuck 40. For added rigidity, the opposing inboard flange 53 may also be constrained using one of two approaches. As shown in FIG. 6, the first approach is to add a freestanding rigidizing flange clamp 80 to the pre-machined axial clamping area “C2” of the inboard flange 53. The flange clamp 80 comprises a radially-segmented, flexible diaphragm 81 with an inwardly-turned lip 82 engaging the clamping area “C2”. The diaphragm 81 is actuated by an axially movable push/pull arm 83. As this is a separate fixturing activity, this can be done outside the normal machining cycle. A second solution utilizes a modified conventional lathe chuck 90 that integrates a similar second flange clamp 91 on an axial slide 92 (tailstock) to adjust for various widths, and insertion and removal of the wheel shape 41, as illustrated in FIG. 7. In this embodiment, the advancement of the axial slide 92 also provides the force necessary to positively locate the wheel shape 41 on the rest pads 93 and 94 of the chuck 90.

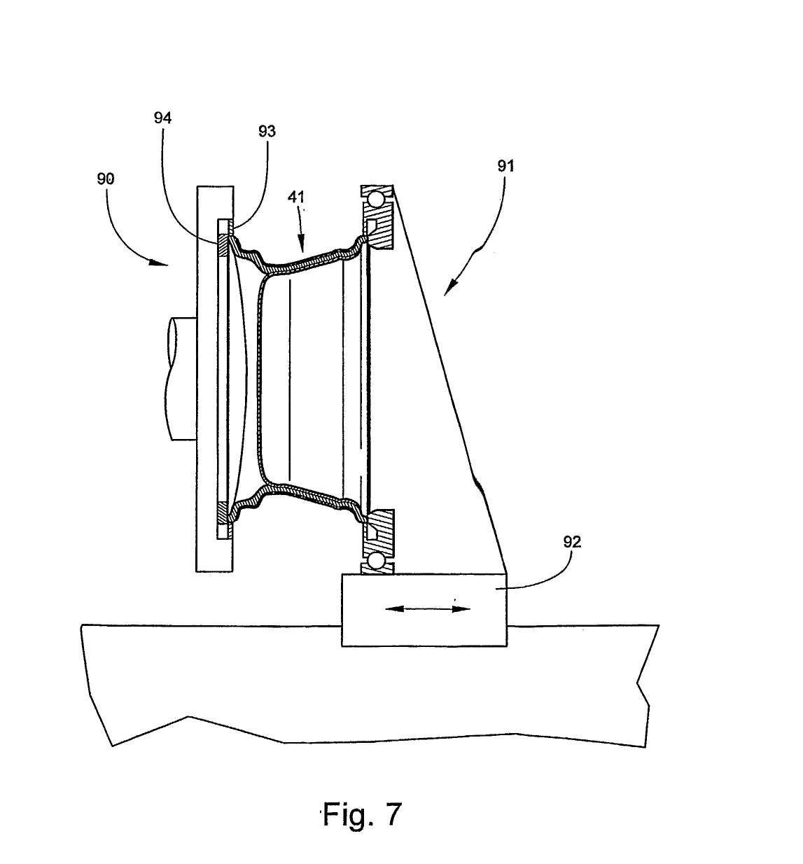

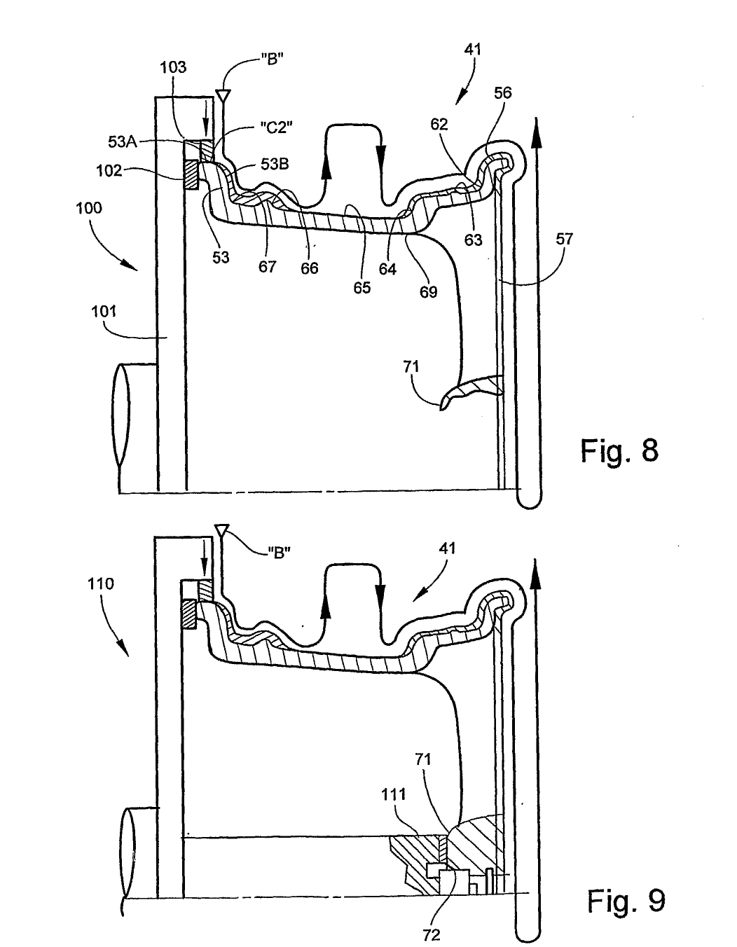

In another embodiment, the present method comprises a more conventional inboard-first and outboard-second operation turning approach. In the second operation (demonstrated in FIG. 8) and shown along path “B”, the wheel shape 41 is secured by chuck 100 along the axial lip 53A of the inboard flange 53 defining the small axial clamping area “C2”—in the range of 4-6 mm. The chuck 100 comprises a flexible diaphragm 101, such as previously described, and rest pads 102 and 103 which cooperate to locate and uniformly engage the wheel shape 41 along its entire circumference. In this turning, the machining tool is moved vertically downward onto the wheel shape 41 to form a vertical wall 53B of the inboard flange 53, inboard tire bead seat 67, inboard tire hump 66, dropwell 64, outboard tire hump 63, outboard tire bead seat 62, outboard flange 56, and remainder of the wheel shape 41, including the wheel face 57—all machined in a single chucking. The initial first operation turning (not demonstrated) formed a portion of the outside rim barrel 65, the axial lip 53A of the inboard flange 53, the inside rim barrel 69, and hub mounting surface 71 and pilot bore (not shown).

In conventional second operation turning only the outboard tire bead seat 62 is machined. In the present method, both the inboard 67 and outboard bead set 62 and flanges 53, 56 are machined in one chucking, thereby improving lateral and radial run out values. In this case, additional machining stock is left in these regions after the first operation turning, so that this improved second operation process is possible. Any wheel face 57 machining is also performed to complete the wheel turning. This alternative embodiment is particularly useful for a flat face wheel that is grasped by the chuck on the inboard rim flange 53 as described, and one where there is close to an effective solid dish center. In this case, the chuck rigidizes the inboard flange 53 while the center rigidizes the outboard flange 56. As a result, the wheel rim is not thrown out of round during high speed revolution.

FIG. 9 shows a chuck 110 including an optional expanding centering collet mandrel 111 that first centers the partially machined wheel shape 41 on the machined hub pilot bore 72, then clamps it on the machined hub mounting surface 71 before the flange clamping actuation is effected. This technique is also used with conventional three-jaw chucks to help ensure concentricity. The cutting path is again indicated at “B”.

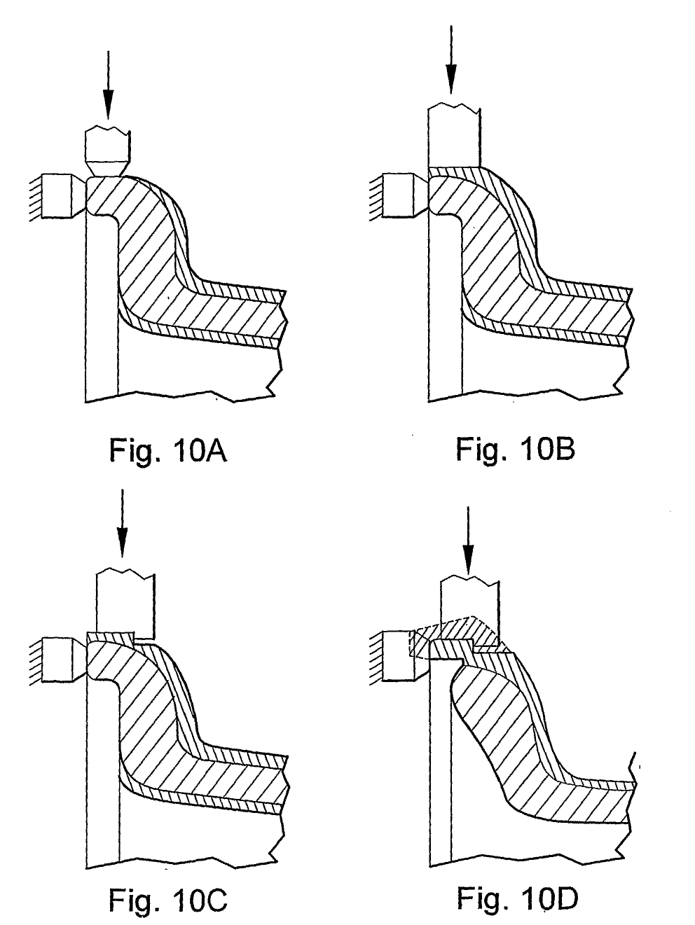

Referring to FIGS. 10A, 10B, 10C, and 10D, while it is possible to clamp an as cast or as forged round part with a circumferential clamp, the desired strong clamping action is most preferably achieved in the very short axial length available on the flange lip by pre-machining the flange to be circumferentially clamped. This was done in the conventional second operation turning referenced above, but it can be advantageous to use the same approach for first operation turning. This requires a pre-turning operation of the wheel shape to form the outboard flange, as shown in FIG. 10A. Note that the final machined flange profile is illustrated, so only the remainder of the wheel shape needs to be turned. Of course, it may also be advantageous to pre-machine an intermediate shape, for example, one that might improve the clamp to flange axial contact, or one that reaches over the flange to better secure the casting, as illustrated in FIGS. 10B and 10C, respectively. Indeed, many wheel shapes are cast with additional axial and radial material at the outboard flange to protect the initial cast or forged shape from cosmetic damage to non-machined face details. This provides an opportunity for an intermediate outboard bead seat clamping surface, as is illustrated in FIG. 10D. In these latter examples, a subsequent flange re-machining to print would be required; however, this region of the flange does not affect wheel trueness.

A significant advantage of the above-described embodiments of the present method is the ability to achieve higher speed turning of the wheel shape to more efficiently form the vehicle wheel. When clamped in a conventional steel three-jaw chuck and turned above a certain rotational speed, the wheel shape generally experiences roundness errors. Since the centrifugal loading of the rim increases dramatically as the rotational speed is increased, the light alloy rim elastically expands relative to the steel chuck. Then, the three-jaw clamps do not allow the rim to expand in the clamped region, and the round casting or forging is not effectively round when the metal cutting takes place. When the rotational loading is removed, a non-round rim results in the relaxed state. This particular phenomenon can be exacerbated by the particular centering mechanism used. In the present method, the centering and clamping are combined, and are also effected through complete or chiefly complete flange clamping. Consequently, there can be no uneven centrifugal loading affects, and higher revolution turning becomes practical.

All the above approaches and advantages of the subject method are suited to either vertical or horizontal machining of wheel shapes and cup-like parts. While there is some evidence that vertical lathes produce better run-out values with conventional three-jaw chucks, the present method virtually eliminates this potential disadvantage. Further, because the complete and uniform flange gripping approach effectively rigidizes the rim, this method is eminently suited to machining and/or re-machining of rim or other flanged tubular parts that are very difficult to machine without an attached center member.

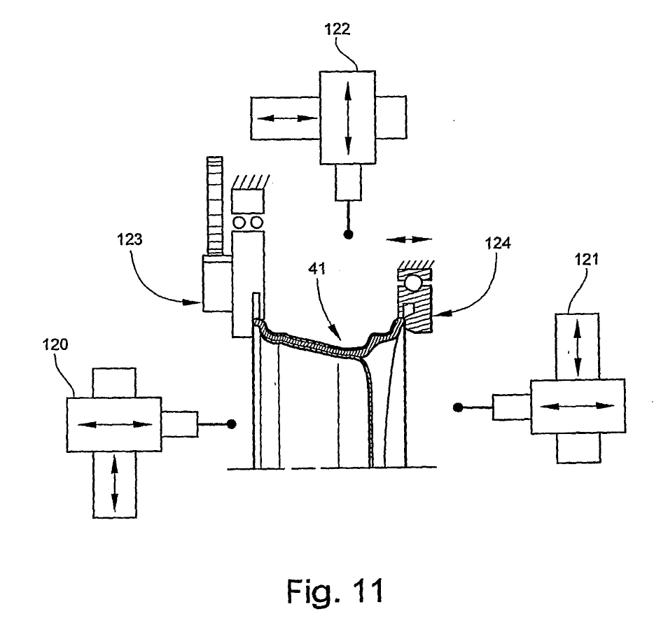

As indicated above, the combined full centering and clamping action of the pre-machined flange greatly reduces, or even eliminates, the need for the typical second operation central expanding mandrel collet for the hub pilot bore centering, as shown in FIG. 9. Thus, by centering and clamping a wheel shape or other cup-shaped part completely from the outside, a new turning machine design is possible. FIG. 11 illustrates schematically a novel six-axis lathe comprising three machining tools 120, 121, and 122. This lathe includes chuck 123 and a second flange clamp or tailstock 124, such as illustrated in FIG. 6. The large clearance bore of the lathe allows the two-axises of the inside machining tool 120 to fully turn the interior of the wheel shape 41 while a separate but similar two-axis machining tool 121 cuts the wheel face. The third two-axis machining tool 122 cuts the rim exterior portion of the wheel shape 41. Thus, this novel lathe enables full wheel turning of any normal wheel styling variant in one machine chucking, once the flange pre-machining step has taken place.

A method for forming a vehicle wheel is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A method for forming a vehicle wheel comprising a wheel rim defining opposing inboard and outboard annular flanges, inboard and outboard tire bead seats adjacent respective inboard and outboard flanges, and a rim barrel between the inboard and outboard tire bead seats, the method comprising the steps of:
(a) machining a wheel shape in a clamping area adjacent one of the inboard and outboard flanges of the vehicle wheel;
(b) without distorting the wheel shape, securing the clamping area of the wheel shape within a chuck of a lathe; and
(c) in one chucking, machining the wheel shape to form the inboard and outboard tire bead seats of the vehicle wheel.

2. A method according to claim 1, wherein the clamping area of the wheel shape defines an axial dimension of less than 10 mm.

3. A method according to claim 1, and comprising in step (c), further machining the wheel shape to form opposing inside and outside surfaces of the rim barrel.

4. A method according to claim 1, and comprising in step (c), further machining the wheel shape to form a hub mounting surface on an inboard side of the vehicle wheel.

5. A method according to claim 1, and comprising in step (a), further machining the wheel shape to form a wheel face on an outboard side of the vehicle wheel.

6. A method according to claim 1, and comprising before step (c), machining a second clamping area adjacent the other of the inboard and outboard flanges.

7. A method according to claim 6, and comprising before step (c), securing the second clamping area of the wheel shape within a rotatable tailstock.

8. A method for forming a vehicle wheel comprising a wheel rim defining opposing inboard and outboard annular flanges, inboard and outboard tire bead seats adjacent respective inboard and outboard flanges, and a rim barrel between the inboard and outboard tire bead seats, the method comprising the steps of:
(a) securing a wheel shape within a chuck of a lathe, the chuck uniformly engaging substantially an entire circumference of the wheel shape along an axial clamping area; and
(b) in one chucking, machining the wheel shape to form the inboard and outboard tire bead seats of the vehicle wheel.

9. A method according to claim 8, wherein the axial clamping area of the wheel shape defines an axial dimension of less than 10 mm.

10. A method according to claim 8, wherein the axial clamping area is pre-machined.

11. A method according to claim 8, and comprising in step (b), further machining the wheel shape to form opposing inside and outside surfaces of the rim barrel.

12. A method according to claim 8, and comprising in step (b), further machining the wheel shape to form a hub mounting surface on an inboard side of the vehicle wheel.

13. A method according to claim 8, and comprising before step (b), securing the wheel shape within a rotatable tailstock, the tailstock engaging an opposing periphery of the wheel shape along a second axial clamping area.

14. A method according to claim 13, wherein the second axial clamping area is pre-machined.

15. A method for forming a vehicle wheel rim defining an annular flange and a tire bead seat adjacent the annular flange, the method comprising the steps of:
(a) machining a wheel shape in a clamping area adjacent the annular flange of the wheel rim;
(b) without distorting the wheel shape, securing the clamping area of the wheel shape within a chuck of a lathe; and
(c) while secured within the chuck of the lathe in step (b), machining the wheel shape adjacent the clamping area to form the tire bead seat of the wheel rim.

16. A method according to claim 15, and comprising in step (c), further machining the wheel shape to form a barrel of the wheel rim.

17. A method according to claim 15, wherein the clamping area of the wheel shape defines an axial dimension of less than 10 mm.

18. A method for forming a vehicle wheel rim defining an annular flange and a tire bead seat adjacent the annular flange, the method comprising the steps of:
(a) securing a wheel shape within a chuck of a lathe, the chuck uniformly engaging an outside periphery of the wheel shape along an axial clamping area; and
(b) while secured within the chuck of the lathe in step (a), machining the wheel shape adjacent the axial clamping area to form the tire bead seat of the wheel rim.

19. A method according to claim 18, wherein the clamping area of the wheel shape defines an axial dimension of less than 10 mm.

20. A method according to claim 18, and comprising in step (b), further machining the wheel shape to form a barrel of the wheel rim.
